(19) United States
(12) Patent Application Publication
(10) Pub. No.: US 2010/0303977 A1
(43) Pub. Date: Dec. 2, 2010

(54) COMPOSITION FOR PROTECTING MEAT OR FISH

(76) Inventors: Majda Hadolin Kolar, Zetale (SI); Andreja Rizner Hras, Race (SI); Simona Urbancic, Ptuj (SI); Duska Dimitrijevic, Maribor (SI); Ohad Cohen Ovadya, Zichron Yaakov (IL)

Correspondence Address: Pearl Cohen Zedek Latzer, LLP, 1500 Broadway, 12th Floor, New York, NY, 10036, US

(21) Appl. No.: 12/745,122

(22) PCT Filed: Apr. 3, 2008
(86) PCT No.: PCT/IL08/00463

§ 371 Date: May 27, 2010

Related U.S. Application Data
(60) Provisional application No. 60/991,064, filed on Nov. 29, 2007.

(51) Int. Cl. A23B 4/20; A23L 1/314

(52) U.S. Cl. 426/281; 426/542

(57) ABSTRACT

The invention provides a formulation for protecting meat against oxidation comprising a rosemary extract an emulsifier and a salt. In some embodiments of the invention, the formulation is free from vegetable or animal oil or fat. The invention also provides a method for inhibiting oxidation of an oxidizable lipid material in food, comprising the step of contacting the lipid material with a formulation comprising a rosemary extract, an emulsifier and a salt. In addition, there is provided a method for inhibiting rancidity in meat, comprising the step of contacting the meat with a formulation comprising a rosemary extract, an emulsifier and a salt.

### BACKGROUND OF THE INVENTION

Oxidation of meat lipids is a complex process and its dynamics depends on numerous factors, including the chemical composition of the meat, and exposure to light and oxygen, as well as storage temperature. The rate of oxidation is also affected by technological procedures to which meat is subjected during its processing. Because lipid oxidation leads to the formation of numerous other compounds, which have adverse effects on the quality and nutritive value of meat products, this process frequently limits the shelf-life of processed meat. Ham and related products are exposed to oxidative degradation more than fresh meat due to a longer shelf-life. Slicing of these products leads to severe oxidative degradation. The fat content of ham ranges from 6% (lean hams) to 30%, and fat spoilage (rancidity) is therefore largely responsible for changes in the flavor profile.

One of the methods for reducing lipid oxidation is the application of antioxidants. Since fat and fat-soluble components must be protected, use of oil-soluble antioxidants is recommended.

Ascorbic acid and its salts, or erythorbic acid and its salts, are usually used for antioxidative protection of ham. The dosage of erythorbic acid and its salts is restricted by law and should not exceed 0.05%.

### SUMMARY OF THE INVENTION

In an embodiment of the invention, there is provided a formulation for protecting meat against oxidation comprising rosemary extract, an emulsifier and a salt.

In some embodiments of the invention, the formulation is free from vegetable or animal oil or fat.

In some embodiments of the invention, the formulation is mixed with brine prior to the administration to the meat.

In an embodiment of the invention, there is provided a method for inhibiting oxidation of an oxidizable lipid material in food, comprising the step of contacting the lipid material with a formulation comprising rosemary extract, an emulsifier and a salt.

In an embodiment of the invention, there is provided a fresh, processed or defrosted meat injected with the formulation of the invention.

In an embodiment of the invention, there is provided a dry salted meat processed with the formulation of the invention.

In an embodiment of the invention, the amount of each of carnosic acid or emulsifier, in the dry salted, fresh, processed or defrosted meat is at least 1 ppm, or 2.5 ppm, respectively.

### BRIEF DESCRIPTION OF THE DRAWINGS

FIG. 1: Results of rancimat test (performed 100° C.) of fat, which was extracted from ham after production. Ham was produced by injection procedure and stabilized with rosemary extract-based formulation, commercial product and the synthetic antioxidant sodium ascorbate.

FIG. 2: Results of rancimat test (performed 100° C.) of fat, which was extracted from ham after storage for 5 weeks at 4° C. Ham was produced by injection procedure and stabilized with rosemary extract-based formulation, commercial product and the synthetic antioxidant sodium ascorbate.

FIG. 3: Results of TBA-value measurement of ham after production. Ham was produced by injection procedure and stabilized with rosemary extract-based formulation, commercial product and the synthetic antioxidant sodium ascorbate.

FIG. 4: Results of TBA-value measurement of ham after storage for 5 weeks at 4° C. Ham was produced by injection procedure and stabilized with rosemary extract-based formulation, commercial product and the synthetic antioxidant sodium ascorbate.

FIG. 5: Results of rancimat test (performed 100° C.) of fat, which was extracted from ham after production. Ham was produced by dry salting procedure and stabilized with rosemary extract-based formulation, commercial product and synthetic antioxidants sodium ascorbate and ascorbic acid.

FIG. 6: Results of rancimat test (performed 100° C.) of fat, which was extracted from ham after storage for 6 weeks at 4° C. Ham was produced by dry salting procedure and stabilized with rosemary extract-based formulation, commercial product and the synthetic antioxidants sodium ascorbate and ascorbic acid.

FIG. 7: Results of TBA-value measurement of ham after production. Ham was produced by dry salting procedure and stabilized with rosemary extract-based formulation, commercial product and the synthetic antioxidants sodium ascorbate and ascorbic acid.

FIG. 8: Results of TBA-value measurement of ham after storage for 6 weeks at 4° C. Ham was produced by dry salting procedure and stabilized with rosemary extract-based formulation, commercial product and the synthetic antioxidants sodium ascorbate and ascorbic acid.

FIG. 9: Results of aerobic plate count (APC) evaluation of ham made by dry salting procedure after storage for 6 weeks at 4° C. Ham was stabilized with rosemary extract-based formulation, commercial product and the synthetic antioxidants sodium ascorbate and ascorbic acid.

### DESCRIPTION OF THE DETAILED EMBODIMENTS OF THE INVENTION

In an embodiment of the invention, there is provided a formulation for protecting meat against oxidation comprising a rosemary extract, an emulsifier and a salt.

In some embodiments of the invention, the formulation is free from vegetable or animal oil or fat.

In an embodiment of the invention the amount of the carnosic acid is between 1-20%. In another embodiment the amount is less than 15%. In another embodiment, the amount is less than 10%. In another embodiment the amount is less than 5%. In another embodiment, the amount is about 4%.

In some embodiments of the invention, the formulation is mixed with brine prior to the administration to the meat. In another embodiment the formulation may be mixed with other additives and applied to the meat or add directly onto the meat.

In an embodiment of the invention, the emulsifier is Di-Acetyl Tartrate Ester of Monoglyceride (DATEM), gum Arabic, distilled monoglycerides, lecitin, xanthan gum, guar gum, calcium carbonate, diacetyltartarric and fatty acid esters of glycerol, glycerol ester of wood rosin, hydroxypropyl distarch phosphate, mycrocrystalline cellulose, pectins, phosphates, polyethylene glycol, polysorbates, polyvinylpyrolidone, potassium dihydrogen citrate, powdered cellulose, propylene glycol esters of fatty acids, salts of myristic, palmitic & stearic acids (NH4, Ca, K, Na), sodium dihydrogencitrate, stearyl citrate, sucrose acetate isobutyrate, tartrates, toson, tripotassium citrate, or trisodium citrate or combination thereof.

In an embodiment of the invention, the emulsifier is a food grade emulsifier. In an embodiment of the invention 5-50% emulsifier is added. In an embodiment of the invention, the amount of the emulsifier is less than 40%. In another embodiment of the invention, the amount of the emulsifier is less than 30%. In another embodiment of the invention, the amount of the emulsifier is less than 20%. In another embodiment of the invention, the amount of the emulsifier is less than 10%.

In an embodiment of the invention, an anti-caking agent is added to the formulation. The amount of the anti-caking agent is between 0.01% and 30%. In an embodiment of the invention, the amount is less than 25%. In another embodiment of the invention, the amount is less than 20%. In another embodiment of the invention, the amount is less than 15%. In another embodiment of the invention, the amount is less than 10%. In another embodiment of the invention, the amount is less than 5%. In another embodiment of the invention, the amount is less than 3%. In another embodiment of the invention, the amount is less than 2%. In another embodiment of the invention, the amount is less than 1%.

In an embodiment of the invention, an antifoaming agent is further added. The antifoaming agent maybe any of the following or any combination thereof: microcrystalline wax, polydimethylsiloxane, polyethylene glycol, polysorbates, stearyl citrate and triethyl citrate

In an embodiment of the invention, the amount of the rosemary extract is calculated so as to provide as to provide up to 50% carnosic acid in the formulation. In another embodiment, the amount is calculated so as to provide less than 40% carnosic acid in the formulation. In another embodiment, the amount is calculated so as to provide less than 30% carnosic acid in the formulation. In another embodiment, the amount is calculated so as to provide less than 20% carnosic acid in the formulation. In another embodiment, the amount is calculated so as to provide less than 10% carnosic acid in the formulation.

The formulation of the invention provides better solubility of the carnosic acid in brine as compared to a formulation containing oil, in which the carnosic acid floats to the top of the brine after preparation.

Further, the formulation of the invention enables better penetration into the meat as compared to commercial product (as can be clearly seen from the Examples related to carnosic acid distribution through meat piece). The reason is attributed to the fact that the formulation of the invention does not contain oil and is animal and vegetable oil free. In contrast, all commercial products in the market contain oil, which floats on the top of the injection brine or remains in the meat surface at dry salting procedure. The oil becomes rancid and as such may act as pro-oxidative. Introducing of oil containing product into the meat or the fish causes introduction of free radicals to the meat and accelerates oxidation process.

In some embodiments of the invention, the formulation is in a form of a powder. This enables easier handling of the resulted product that can be easily mixed with other additives that are also in a form of a powder. This is more relevant for the dry salt procedure.

In another embodiment, the formulation is in a form of a paste.

In one embodiment of the invention, there is provided a method for inhibiting oxidation of an oxidizable lipid material in food, comprising the step of contacting the lipid material with a formulation comprising a rosemary extract, an emulsifier and a salt.

In another embodiment, there is provided a method for inhibiting rancidity in meat, comprising the step of contacting the meat with a formulation comprising a rosemary extract, an emulsifier and a salt.

The term “lipid material” refers herein in the invention to a substance which is insoluble in water, but soluble in fat solvents such as alcohol and ether. In an embodiment of the invention the lipid material is contained in a meat or a fish.

In an embodiment of the invention, the step of contacting is by injection of said formulation into the fresh or defrosted meat.

In another embodiment, the step of contacting is by mixing meat pieces with the formulation of the invention together with salt and optionally spices so as to obtain dry salted meat.

At dry salting procedure the curing mixture of the formulation of the invention and other ingredients (salt and spices) is added to each piece of meat. Meat pieces are moved into a stainless steel container until it is full. The container is closed and kept in a temperature from 2-4° C. Every two days the container is opened and the meat pieces are removed in the container. The container is closed again. The procedure of replacing the pieces lasts for 14 days.

In another embodiment of the invention, the formulation is used in wet salting procedure. The formulation of the invention is dissolved in water and brine and is injected and/or added to the meat or fish pieces.

In an embodiment of the invention, there is provided a fresh or a defrosted meat or fish injected and/or immersed with the formulation of the invention.

In an embodiment of the invention, there is provided dry salted meat or fish processed with the formulation of the invention.

In an embodiment of the invention, there is provided processed meat or fish processed with the formulation of the invention.

In an embodiment of the invention, the “processed meat or fish” may be any of the following meat and meat products (fresh meat, fresh spiced meat, fresh sausages, mortadella type sausages, parisien type sausages, blood sausages, hot dog type sausages, cooked sausages, salamis, dry cured products, cooked cured products, pastrami and more), fish and fish products, pate type meat and fish products, fast food, thermally processed foods and pre-prepared food (frozen, shelf-stable, refrigerated)

In an embodiment of the invention, the fresh or a defrosted meat or fish comprises carnosic acid or emulsifier or any combination thereof.

In an embodiment of the invention, the fresh or a defrosted meat or fish comprises carnosic acid or DATEM or any combination thereof.

In an embodiment of the invention, the fresh or defrosted meat or fish contains solely naturally presented fat. Fresh meat as well as meat after any process herein has a known fatty acids composition (ratio between fatty acids). If additional fat is added, the ratio is changed and accordingly it is possible to determine whether additional fat was added.

In an embodiment of the invention, the amount of each of carnosic acid or DATEM is at least 0.1 ppm, or 0.25 ppm, respectively.

In an embodiment of the invention, the amount of each of carnosic acid or DATEM t is at least 0.5 ppm, or 0.5 ppm, respectively

In an embodiment of the invention, the amount of each of carnosic acid or DATEM is at least 1 ppm, or 2.5 ppm, respectively.

In an embodiment of the invention, the dry salted meat or fish comprises carnosic acid or emulsifier or any combination thereof. In an embodiment of the invention, the dry salted meat or fish comprises carnosic acid or DATEM or any combination thereof.

In an embodiment of the invention, the dry salted meat contains solely naturally presented fat.

In an embodiment of the invention, the amount of each of carnosic acid or DATEM in the dry salted meat is at least 0.1 ppm, or 0.25 ppm, respectively.

In an embodiment of the invention, the amount of each of carnosic acid or DATEM in the dry salted meat is at least 0.5 ppm, or 0.5 ppm, respectively.

In an embodiment of the invention, the amount of each of carnosic acid or DATEM in the dry salted meat is at least 1.0 ppm, or 2.5 ppm, respectively

In an embodiment of the invention, the wet salted meat or fish comprises carnosic acid or emulsifier or any combination thereof.

In an embodiment of the invention, the wet salted meat or fish comprises carnosic acid or DATEM or any combination thereof.

In an embodiment of the invention, the wet salted meat or fish contains solely naturally presented fat.

In an embodiment of the invention, the amount of each of carnosic acid or DATEM in the wet salted meat or fish is at least 0.5 ppm, or 0.5 ppm, respectively.

In an embodiment of the invention, the amount of each of carnosic acid or DATEM in the wet salted meat or fish is at least 0.1 ppm, or 0.25 ppm, respectively

In an embodiment of the invention, the amount of each of carnosic acid or DATEM in the wet salted meat or fish is at least 1 ppm, or 2.5 ppm, respectively.

### EXAMPLES

### The Rosemary Extract Formulation

The efficiency of the rosemary extract formulation as set forth in Table 1 below was compared to the synthetic antioxidant sodium ascorbate and to a commercial formulation composed of rosemary extract, polysorbate 80, vegetable oil and silicones.

TABLE 1
Rosemary extract formulation

| Material | % W/W | Function |
|---|---|---|
| rosemary extract | amount is calculated | antioxidative and |
| | on 4% carnosic acid | antimicrobial |
| | in final formulation | properties |
| DATEM in powder form gum | 5-20% | food-grade |
| arabic, distilled | | emulsifier |
| monoglycerides or any other | | |
| food-approved emulsifier | | |
| in powder form | | |
| silicon dioxide | 2% | anti-caking agent |
| salt | up to 100% | carrier |

The rosemary extract formulation was tested at concentrations of 0.005%, 0.01%, 0.02%, 0.05% and 0.1%.

The antioxidant activity of the rosemary extract formulation was compared to the commercial formulation at a concentration of 0.1%.

The rosemary extract formulation was further compared to sodium ascorbate as a gold standard at a concentration of 0.05%, and to a control sample (that did not contain any antioxidants).

### Experimental Procedures

### Meat Injection

The experiment was conducted in ham containing 20% fat. 100 l of injection brine was prepared for each experiment and contained:

4-5% phosphates (sodium and potassium di- and tri-phosphates)
0.3-1% optional other ingredients (dextrose and/or caragenans and/or potato starch and/or proteins (from different sources) and/or flavour enhancer (sodium glutaminate) and/or spice extracts and/or spices and/or colour and/or fibres and more)
5-9% salt (edible salt commonly used for fresh meat and nitrite for meat products)
antioxidant
suitable amount of the rosemary extract formulation: 5 g/l for 0.1% dosage, 2.5 g/l for 0.05% dosage, 1 g/l for 0.02% dosage; 0.5 g/l for 0.01% dosage and 0.25 g/l for 0.005% dosage or
suitable amount of commercial product: 5 g/l for 0.1% dosage or
suitable amount of sodium ascorbate: 2.5 g/l for 0.05% dosage
   water

A preparation tank was filled with cold water, the rosemary extract formulation was added and mixed throughout the experiment. After all the ingredients were dissolved, edible salt or nitrite salt was added. Cooled brine (from 2-4° C.) was added to the meat by injection (20% injection) and/or tumbling, dipping or by combination of all procedures. The meat was then prepared for thermal treatment (cording, hanging meat pieces, etc.), thermal treatment was conducted (until the temperature in the product center reached at least 75° C.), cooled immediately and stored at an appropriate temperature.

### Sensory Control

A trained panel of ten people was used for evaluation of extract flavour and taste impact in final meat application. The panel tasters used a descriptive scoring test, namely, a form of rating using a numerical scale, in which the scores bear meaningful mathematical relationships. Coded samples were presented simultaneously to the panel in a controlled presentation order. The panel tasters were asked to identify/score the following parameters: colour of cut throughout, strange aroma, bitterness and strange taste. The results were statistically processed.

### Rancimat Test

The Rancimat test measures the conductivity of low molecular weight fatty acids produced during autoxidation of fats. The oxidative stability was determined by Rancimat test at 100° C. Results are presented as a function of induction time. Higher induction time indicates better oxidative stability of the product.

### TBA Test

The TBA test is a method for determination of lipid peroxidation in meat products. The TBA test quantitatively determines the amount of an end product of lipid oxidation, malondialdehyde (MDA), reacting with thiobarbituric acid (TBA) so as to produce a red pigment with a fixed absorption spectrum. Results are presented as a TBA value in mg of malonalehyde/kg of meat. A lower TBA value indicates better oxidative stability of the product.

### Microbiological Evaluation

A sample of the meat product was weighed into a sterile bag. An appropriate amount of diluent (sterile 0.9% NaCL) was added and the sample was homogenized. One ml of sample was transferred to the centre of RIDA®COUNT Total plate. The plate was incubated at a temperature of 35° C.±1° C. for 48 hours (±2 hours) and colonies were counted after incubation.

### Dry Salting Procedure

The efficiency of 0.005%, 0.01%, 0.02%, 0.05% and 0.1% rosemary extract formulation (Table 1) was compared to the synthetic antioxidants ascorbic acid and sodium ascorbate and a commercial formulation as described in Table 2.

Ascorbic acid and sodium ascorbate were tested at a concentration of 0.05%. The control sample contained no antioxidants.

The experiment was performed with ham containing 20% fat. A curing mixture (10 kg) of nitrate salt with spices was prepared for each experiment and contained:

80-90% nitrite salt,
10-20% other ingredients (pepper, garlic, laurel leaf and more), and
a suitable amount of rosemary extract formulation: 1 g per kg of meat for 0.1% dosage, 0.5 g per kg of meat for 0.05% dosage, 0.2 g per kg of meat for 0.02% dosage, 0.1 g per kg of meat for 0.01% dosage and 0.05 g per kg of meat for 0.005% dosage, or
a suitable amount of the commercial formulation: 1 g per kg of meat for 0.1% dosage, or
a suitable amount of ascorbic acid: 0.5 g per kg of meat for 0.05% dosage, or
a suitable amount of sodium ascorbate: 0.5 g per kg of meat for 0.05% dosage.

The curing mixture of all mentioned ingredients was added to each piece of meat. Meat pieces were added to a stainless steel container until it was full. The container was closed and kept at a temperature of 2-4° C. Every two days the container was opened and the meat pieces were moved into a new container The procedure of displacing lasted 14 days and was followed by preparation for thermal treatment (cording, meat pieces hanging, etc.), thermal treatment (until the temperature in the product centre reached at least 75° C.), immediate cooling and storage at 4° C.

Sensory control, Rancimat test, TBA test and microbial test were conducted according to the methods described above.

### Example 1

### Injection Procedure

### Sensory Evaluation Results

Hams treated with rosemary extract formulation were perceived by the panel tasters as fresh, meat colour was distributed equally and was redder compared to other samples. None of the panel tasters sensed bitterness or strange smell and taste. In contrast, four out of ten panel tasters in the control group sensed some rancid smell and taste, due to the secondary oxidation products that accumulated. Two out of ten panel tasters sensed a sour after-taste in the sample into which sodium ascorbate was added.

### Rancimat Test Results

The rancimat test results show that the rosemary extract formulation was 30% more efficient than the commercial formulation at the same dosage of carnosic acid in the final product.

Furthermore, the efficiency of rosemary extract formulation was 80% higher in comparison to sodium ascorbate.

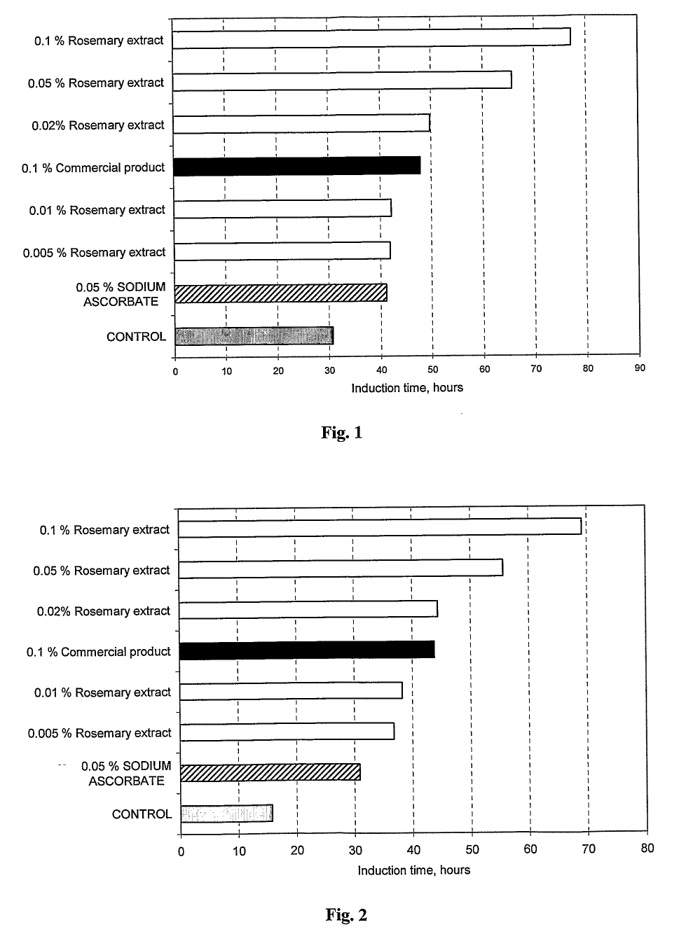

Results of rancimat test measurements of fat extracted from ham immediately after production are presented in FIG. 1. FIG. 2 shows rancimat test results of fat extracted from ham after storage for 5 weeks at 4° C.

### TBA Test Results

TBA test results shows that TBA value of ham treated with rosemary extract formulation was 75% lower than the TBA value for ham treated with the commercial formulation at the same dosage of carnosic acid in the final product. TBA values were four times higher than the rosemary extract formulation compared to sodium ascorbate in ham produced by injection procedure.

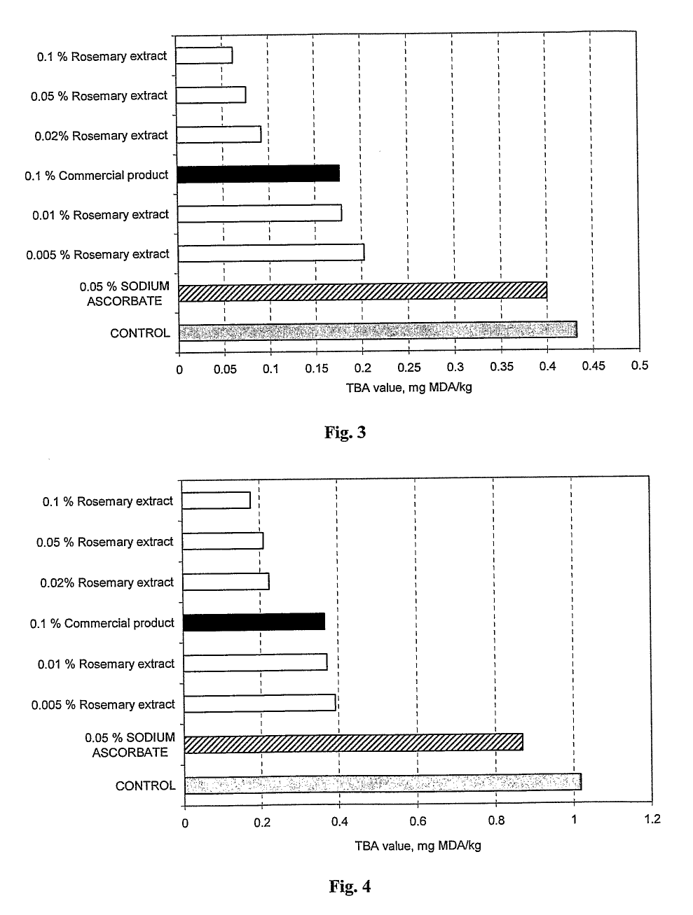

Results of ham TBA value measurements immediately after its production are presented in FIG. 3. FIG. 2 shows TBA measurement results of ham after storage for 5 weeks at 4° C.

### Product Solubility in Injection Brine

The injection procedure requires a uniform distribution of active ingredient in the injection brine. Injection brines included addition of the rosemary extract formulation, the commercial formulation and rosemary extract formulation without an emulsifier. Dosage was calculated at 40 ppm of carnosic acid in the injection brine. The concentration of carnosic acid in the injection brine two hours after preparation was measured by HPLC with electrochemical detection (internal analytical method). Theoretical concentration of carnosic acid in the injection brine should have been 40 ppm. Results are presented in Table 3. As can be seen from the table, solubility or retention of carnosic acid in the injection brine is 30% higher with the rosemary extract formulation than with the commercial formulation. In addition, the results show that the formulation must contain emulsifier to reach solubility of carnosic acid in injection brine. In a product without emulsifier only 12% of carnosic acid remained soluble in the injection brine.

TABLE 3
Product solubility in injection brine

| | Carnosic acid concentration |
|---|---|
| Product | in injection brine |
| Commercial product | 25 ppm |
| Rosemary extract formulation | 39 ppm |
| Rosemary extract formulation without | 5 ppm |
| an emulsifier | |

### Example 2

### Dry Salting Procedure

### Sensory Evaluation Results

The panel tasters perceived the ham treated with the rosemary extract formulation to be fresh, with the meat color distributed equally and redder compared to other samples, and none of the tasters sensed bitterness or strange smell and taste. In the control sample and samples treated with ascorbic acid and sodium ascorbate the panel tasters sensed some rancid smell and taste, due to the secondary oxidation products that accumulated.

### Rancimat Test Results

The rancimat test results show that the rosemary extract formulation was 12 times more efficient than the commercial formulation at the same dosage of carnosic acid in the final product.

Furthermore, the rosemary extract formulation was 12-13 times more efficient in comparison to ascorbic acid and sodium ascorbate in ham produced by the dry salting procedure.

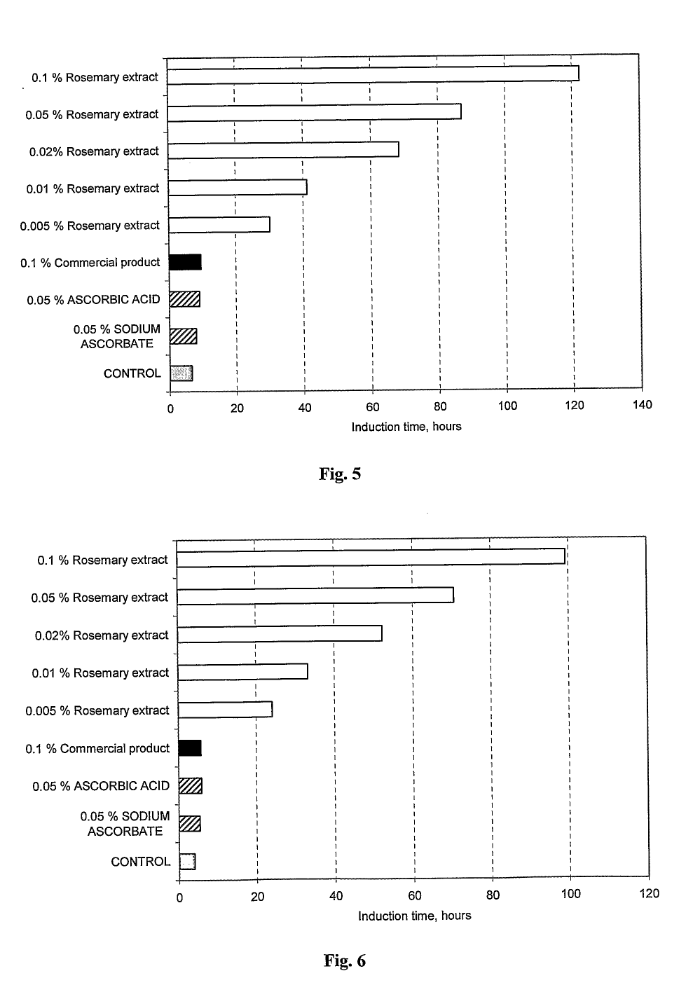

Results of rancimat test measurements of fat extracted from ham immediately after production are presented in FIG. 5.

FIG. 6 shows rancimat test results of fat extracted from ham after storage for 6 weeks at 4° C.

TBA Test Results

The TBA test results showed that the rosemary extract-based formulation outperformed ascorbic acid, sodium ascorbate and the best performing competitor product. The TBA value of the ham with the addition of the rosemary extract formulation was for 50% lower than the TBA value of the product, which was stabilized with the competitor's product at the same dosage of carnosic acid in the final product.

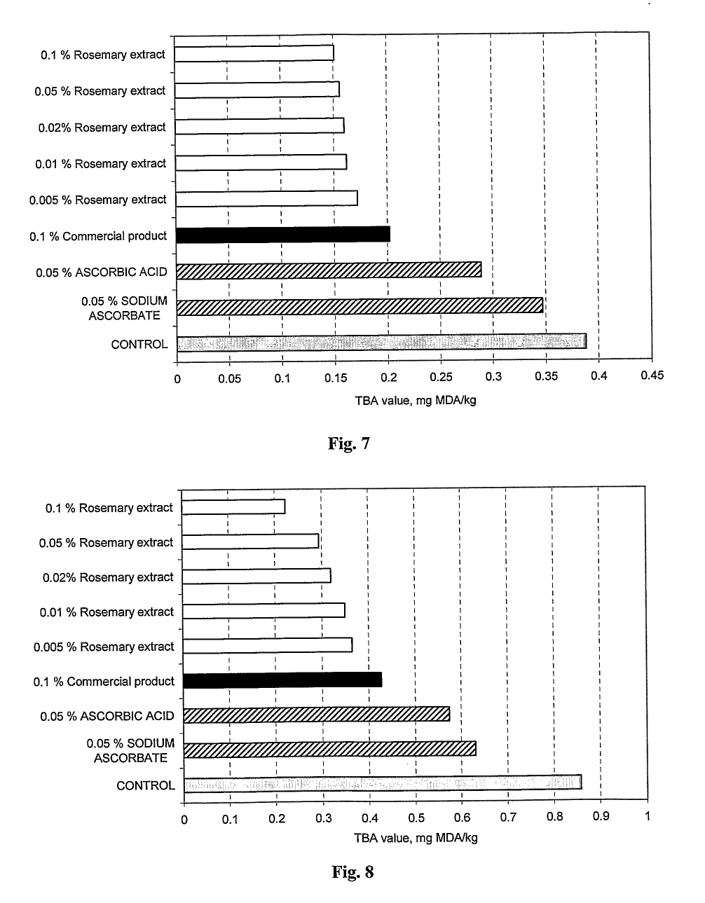

TBA value measurement results showed 2-fold better efficiency of the rosemary extract formulation at 0.05% dosage compared to ascorbic acid and sodium ascorbate in ham produced by the dry salting procedure. Results of ham TBA value measurements immediately after its production are presented in FIG. 7.

FIG. 8 shows TBA measurement results of ham after storage for 5 weeks at 4° C.

### Microbiological Results

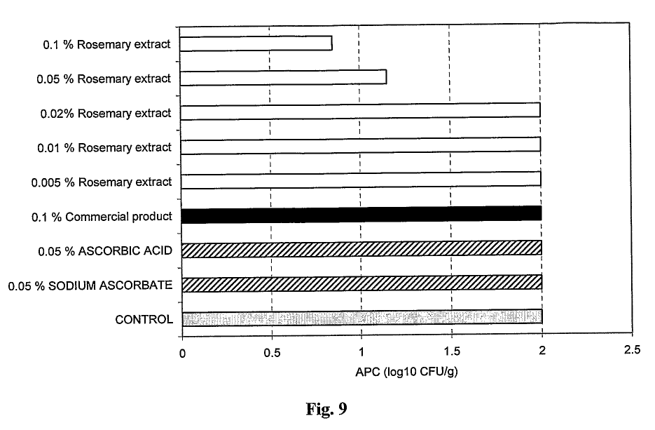

Microbial tests showed that the rosemary extract formulation protects meat against microbiological spoilage. Results are presented in FIG. 9.

Distribution of Active Ingredient Throughout Meat Pieces

The main target of the dry salting procedure is the equal distribution of active ingredients throughout the whole meat piece. Meat pieces with the addition of 0.05% rosemary extract formulation and 0.1% of the commercial product were analyzed for carnosic acid content. Samples were taken from the surface of the meat pieces, in the middle of the meat pieces and between the surface and middle of the meat pieces. Results are presented in Table 4. Theoretically, concentrations of carnosic acid in each part of the meat piece should be 20 ppm. Meat pieces were analyzed after storage for two weeks at 4° C., so some carnosic acid loss due to the protection of meat should be considered.

It may be seen clearly that penetration of carnosic acid into the middle of the meat piece was much better with the rosemary extract formulation than with the commercial formulation.

TABLE 4
Distribution of carnosic acid through meat piece

| | | Carnosic acid |
|---|---|---|
| | Meat piece part | concentration |
| Rosemary extract | surface | 18 ppm |
| formulation | middle | 16 ppm |
| | between surface and middle | 13 ppm |
| Commercial product | surface | 20 ppm |
| | middle | 5 ppm |
| | between surface and middle | 11 ppm |

1-26. (canceled)

27. A formulation in a form of a powder or a paste comprising a rosemary extract, an emulsifier and a salt, wherein the amount of the rosemary extract provides up to 50% carnosic acid in the formulation.

28. The formulation of claim 27, wherein the formulation is free from vegetable or animal oil or fat.

29. The formulation of claim 27, wherein the emulsifier comprises DATEM, gum Arabic, distilled monoglycerides, lecitin, xanthan gum, guar gum, calcium carbonate, diacetyltartarric and fatty acid esters of glycerol, glycerol ester of wood rosin, hydroxypropyl distarch phosphate, mycrocrystalline cellulose, pectins, phosphates, polyethylene glycol, polysorbates, polyvinylpyrolidone, potassium dihydrogen citrate, powdered cellulose, propylene glycol esters of fatty acids, salts of myristic, palmitic & stearic acids (NH4, Ca, K, Na), sodium dihydrogencitrate, stearyl citrate, sucrose acetate isobutyrate, tartrates, toson, tripotassium citrate, and trisodium citrate or combinations thereof.

30. The formulation of claim 27, wherein the formulation is mixed with brine.

31. A method for inhibiting oxidation of an oxidizable lipid material in food, comprising the step of contacting the lipid material with formulation in a form of a powder or a paste comprising a rosemary extract, an emulsifier and a salt, wherein the amount of the rosemary extract provides up to 50% carnosic acid in the formulation.

32. The method of claim 31, wherein the formulation is free from vegetable or animal oil or fat.

33. The method of claim 31, wherein the emulsifier comprises DATEM, gum Arabic, distilled monoglycerides, lecitin, xanthan gum, guar gum, calcium carbonate, diacetyltartarric and fatty acid esters of glycerol, glycerol ester of wood rosin, hydroxypropyl distarch phosphate, mycrocrystalline cellulose, pectins, phosphates, polyethylene glycol, polysorbates, polyvinylpyrolidone, potassium dihydrogen citrate, powdered cellulose, propylene glycol esters of fatty acids, salts of myristic, palmitic & stearic acids (NH4, Ca, K, Na), sodium dihydrogencitrate, stearyl citrate, sucrose acetate isobutyrate, tartrates, toson, tripotassium citrate, and trisodium citrate or combinations thereof.

34. The method of claim 31, wherein the formulation is mixed with brine.

35. The method of claim 31, wherein the lipid material is contained in a meat or a fish.

36. The method of claim 31, wherein the step of contacting is by injection of said formulation into the fresh or defrosted meat or fish.

37. The method of claim 31, wherein the step of contacting is by mixing meat or fish pieces with said formulation and salt so as to obtain dry salted meat or fish.

38. A fresh or defrosted meat or fish injected with the formulation of claim 27.

39. The fresh or defrosted meat of claim 38, wherein the fresh or defrosted meat or fish comprises carnosic acid or DATEM or any combination thereof.

40. The fresh or defrosted meat of claim 38, wherein the fresh or defrosted meat or fish is contains solely naturally presented fat/oil.

41. The fresh defrosted meat or fish of claim 38, wherein the amount of each of carnosic acid or DATEM is at least 1 ppm, or 2.5 ppm, respectively.

42. A dry salted meat or a processed meat or fish injected with the formulation of claim 27.

43. The dry salted meat of claim 42, wherein the formulation comprises carnosic acid, or DATEM or any combination thereof.

44. A method for inhibiting rancidity in meat or a fish, comprising the step of contacting the meat or the fish with a formulation comprising a rosemary extract, an emulsifier and a salt.

45. The method of claim 44, wherein the amount of the rosemary extract provides up to 50% carnosic acid in the formulation.

46. The method of claim 44, wherein the formulation is free from vegetable or animal oil or fat.

47. The method of claim 44, wherein the emulsifier comprises DATEM, gum Arabic, distilled monoglycerides, lecitin, xanthan gum, guar gum, calcium carbonate, diacetyltartarric and fatty acid esters of glycerol, glycerol ester of wood rosin, hydroxypropyl distarch phosphate, mycrocrystalline cellulose, pectins, phosphates, polyethylene glycol, polysorbates, polyvinylpyrolidone, potassium dihydrogen citrate, powdered cellulose, propylene glycol esters of fatty acids, salts of myristic, palmitic & stearic acids (NH4, Ca, K, Na), sodium dihydrogencitrate, stearyl citrate, sucrose acetate isobutyrate, tartrates, toson, tripotassium citrate, and trisodium citrate or combinations thereof.

48. The method of claim 44, wherein the formulation is mixed with brine.
